(19) United States
(12) Patent Application Publication
(10) Pub. No.: US 2011/0282682 A1
(43) Pub. Date: Nov. 17, 2011

(54) Method and System for Collecting Data for Facilitating Assessment of the State of Health of an Individual

(75) Inventor: Robert Whent, Tecumseh (CA)

(73) Assignee: OTEP Inc., Tecumseh (CA)

(21) Appl. No.: 13/154,491

(22) Filed: Jun. 7, 2011

(30) Foreign Application Priority Data
May 11, 2010 (CA) 2703448
Jun. 7, 2010 (CA) 2706031

(51) Int. Cl. G06Q 50/00

(52) U.S. Cl. 705/2

(57) ABSTRACT

A method for collecting data for facilitating the assessment of the state of health of an individual is provided. A first computer program for enabling a user to interact therewith via a user interface is executed. The first computer program enables a second computer program to communicate therewith. The second computer program is executed for communicating with the first computer program for collecting interaction data in dependence upon the interaction of the user with the first computer program. User state data are then determined in dependence upon the interaction data. The user state data are associated with a state of health of the user. The user state data are then provided for facilitating assessment of the state of health of the user.

### FIELD OF THE INVENTION

The present invention relates to the field of assessing the state of health of an individual, and more particularly to a method and system for collecting data for facilitating the assessment of the state of health of an individual.

### BACKGROUND OF THE INVENTION

The assessment of the state of health of an individual to determine, for example, cognitive issues; mental issues; and/or behavioural issues is the foundation for the following steps of proper diagnosis and proper medical treatment of the individual. The assessment typically comprises of having the individual perform a series of tasks alone with a certified or trained assessor in unfamiliar surroundings and usually takes place over a time period of several hours.

Unfortunately, there are numerous factors that negatively influence this type of assessment—such as, for example, having a bad day; headaches; personal trauma; shame; etc.—resulting in an improper assessment and, therefore, improper diagnosis and improper medical treatment. Furthermore, this type of assessment provides only a snapshot in time. In order to provide an accurate assessment it should be performed in privacy, over a period of time.

Another disadvantage of this type of assessment is the need for a certified or trained assessor to be present during the time of the assessment resulting in a substantial workload for specialized practitioners. Therefore, scheduling such an assessment typically takes weeks or months while mental health issues and cognitive deficiencies need to be identified and treated at an early stage.

It is desirable to provide a method and system for collecting data for facilitating the assessment of the state of health of an individual while the individual is in a private setting.

It is also desirable to provide a method and system for collecting data for facilitating the assessment of the state of health of an individual over a period of time.

It is also desirable to provide a method and system for collecting data for facilitating the assessment of the state of health of an individual in a concealed fashion with respect to the individual.

### SUMMARY OF THE INVENTION

Accordingly, one object of the present invention is to provide a method and system for collecting data for facilitating the assessment of the state of health of an individual while the individual is in a private setting.

Another object of the present invention is to provide a method and system for collecting data for facilitating the assessment of the state of health of an individual over a period of time.

Another object of the present invention is to provide a method and system for collecting data for facilitating the assessment of the state of health of an individual in a concealed fashion with respect to the individual.

Another object of the present invention is to provide a method and system for facilitating the assessment of the state of health of an individual without direct input from a health care professional during the initial assessment process.

According to one aspect of the present invention, there is provided a method for collecting data for facilitating the assessment of the state of health of an individual. A first computer program for enabling a user to interact therewith via a user interface is executed. The first computer program enables a second computer program to communicate therewith. The second computer program is executed for communicating with the first computer program for collecting interaction data in dependence upon the interaction of the user with the first computer program. User state data are then determined in dependence upon the interaction data. The user state data are associated with a state of health of the user. The user state data are then provided for facilitating assessment of the state of health of the user.

According to another aspect of the present invention, there is further provided a storage medium having stored therein executable commands for execution on a processor. The processor when executing the commands communicates with a computer program. The computer program when executing enables a user to interact therewith via a user interface. During the communication the processor collects interaction data in dependence upon the interaction of the user with the computer program. The processor then determines user state data in dependence upon the interaction data. The user state data are associated with a state of health of the user. The processor then provides the user state data for facilitating assessment of the state of health of the user.

The advantage of the present invention is that it provides a method and system for collecting data for facilitating the assessment of the state of health of an individual while the individual is in a private setting.

A further advantage of the present invention is that it provides a method and system for collecting data for facilitating the assessment of the state of health of an individual over a period of time.

A further advantage of the present invention is that it provides a method and system for collecting data for facilitating the assessment of the state of health of an individual in a concealed fashion with respect to the individual.

### BRIEF DESCRIPTION OF THE DRAWINGS

A preferred embodiment of the present invention is described below with reference to the accompanying drawings, in which:

FIG. 1 is a simplified block diagram illustrating a computer system for implementing a method for collecting data for facilitating the assessment of the state of health of an individual according to a preferred embodiment of the invention;

FIG. 2a is a simplified flow diagram illustrating a method for collecting data for facilitating the assessment of the state of health of an individual according to a preferred embodiment of the invention; and,

FIG. 2b is a simplified flow diagram illustrating an alternative embodiment of the method for collecting data for facilitating the assessment of the state of health of an individual illustrated in FIG. 2a.

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

While embodiments of the invention will be described for use in assessing mental health issues, cognitive deficiencies, and behavioral issues in children, adolescents and/or adults (hereinafter referred to as “individual” or “individuals”) for the sake of simplicity, it will become evident to those skilled in the art that the embodiments of the invention are not limited thereto, but are also applicable for use in assessing the state of health of an individual in numerous situations such as, for example, assessing the state of health of the elderly, or assessing the state of health of equipment operators such as pilots by collecting data during training on a flight simulator (also sometimes referred to herein as “individual” or “individuals”).

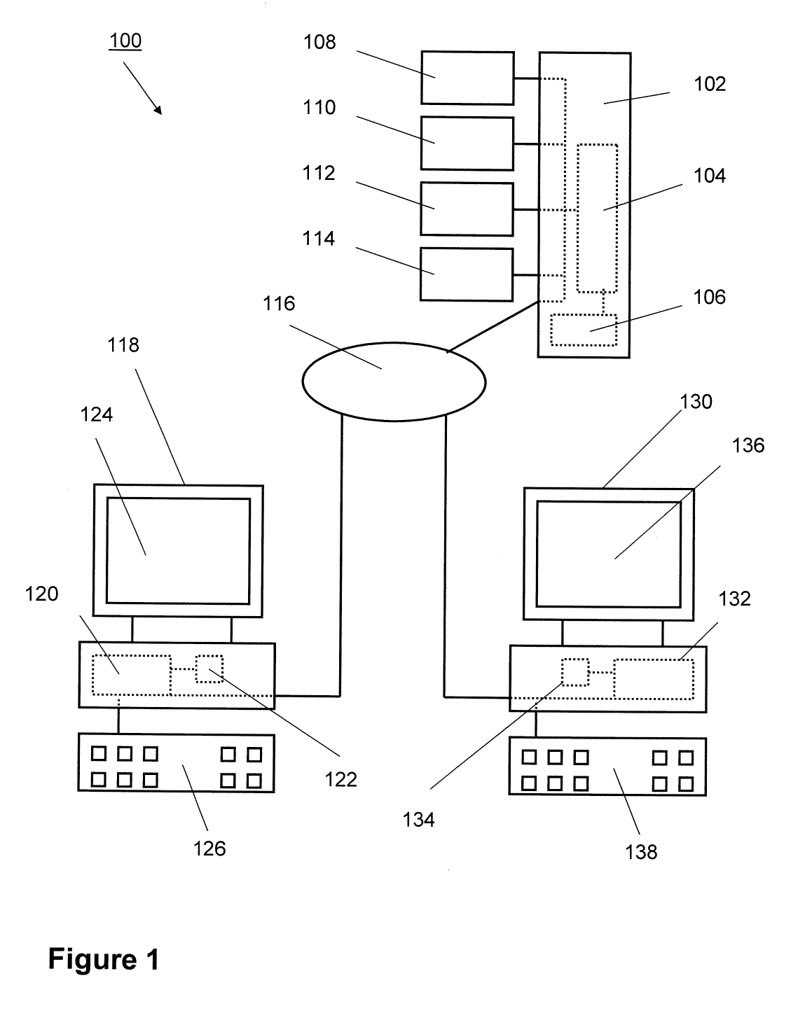

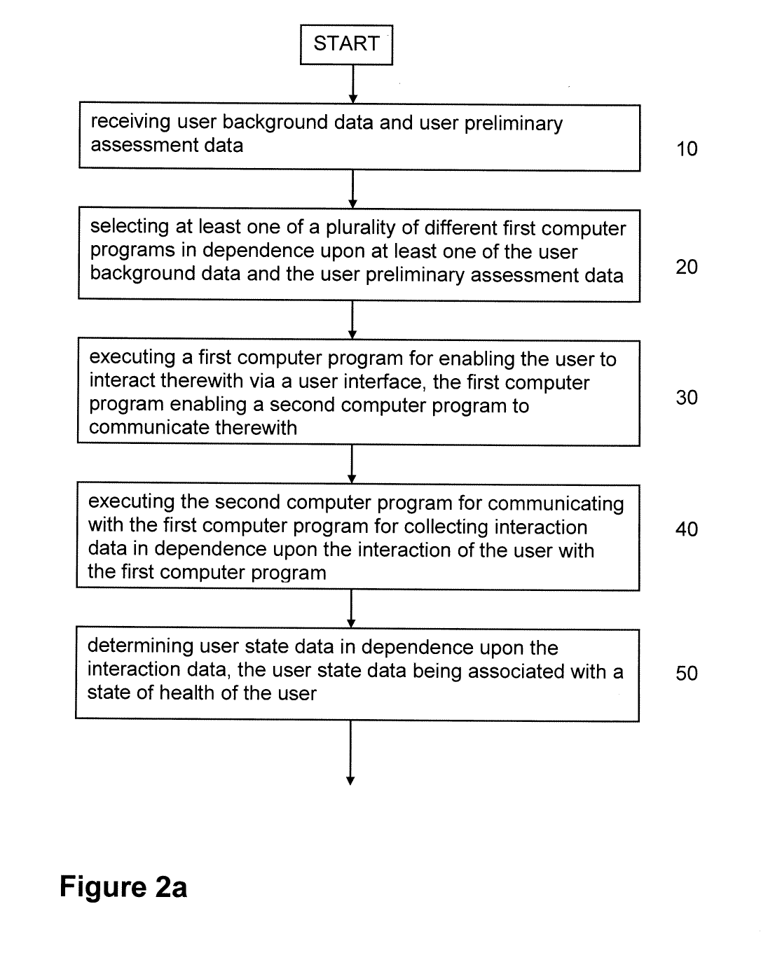

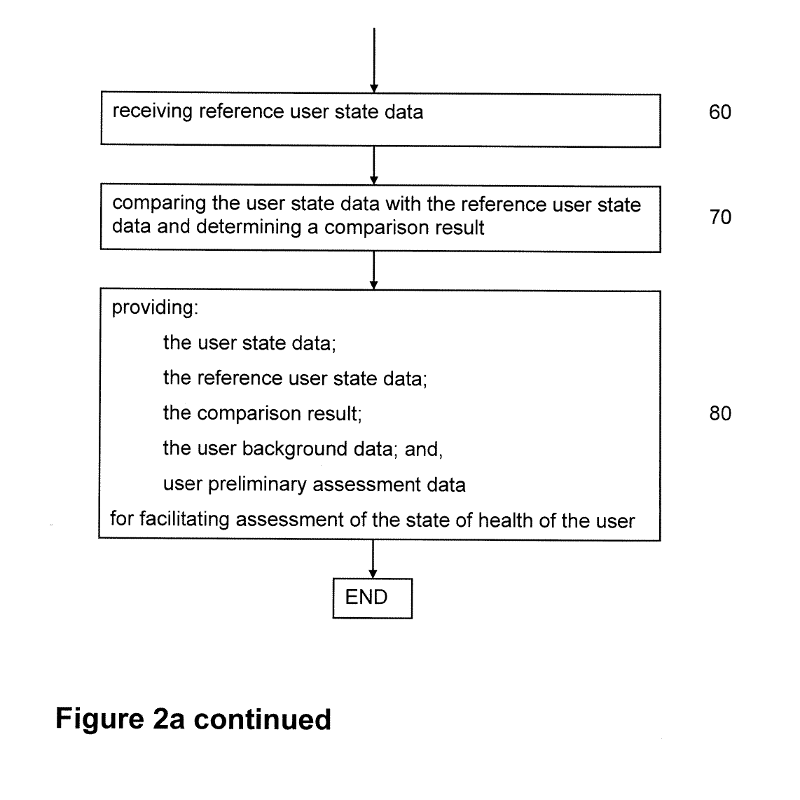

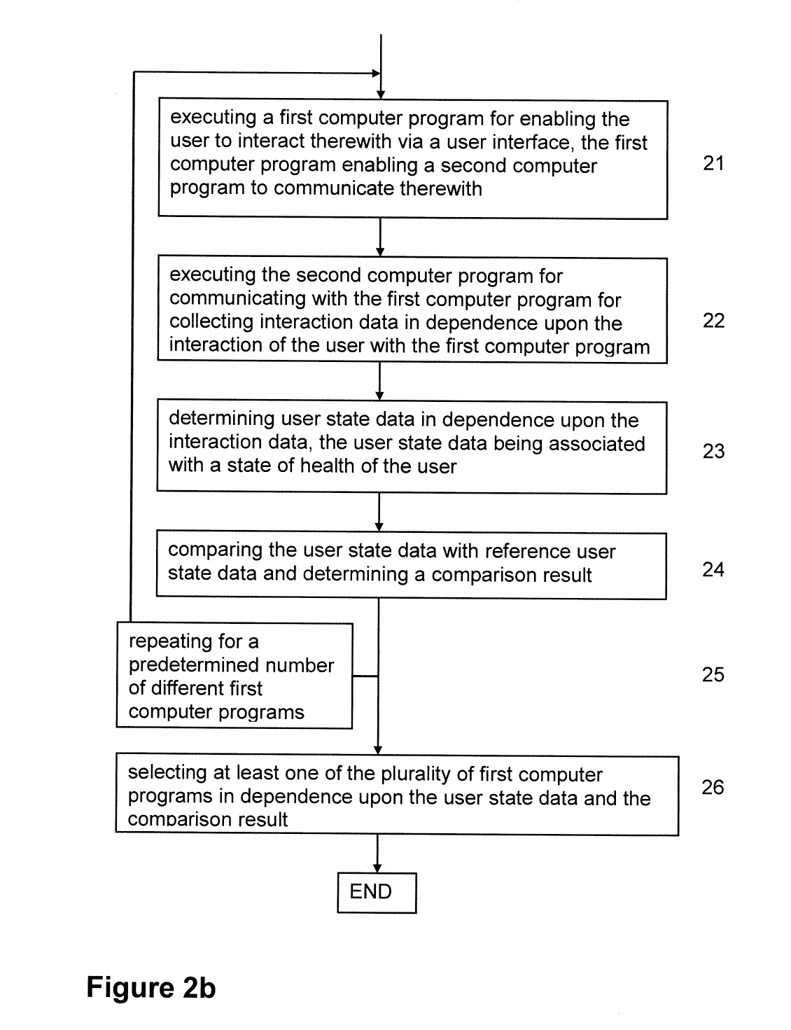

Referring to FIGS. 1, 2a, and 2b, a method for collecting data for facilitating the assessment of the state of health of an individual according to a preferred embodiment of the invention is provided together with a preferred embodiment of a system for its implementation. A personal computer 118 located in a private setting such as the home of a parent or a caregiver of an individual is connected via a communication network 116—such as, for example, the Internet—to a server computer 102 of an assessment service provider. Typically, the personal computer 118 comprises a processor 120, memory 122, monitor 124 and a user interface 126. For example, the parent first signs up with the assessment service provider by logging on to the assessment service provider's website displayed on the monitor 124 to open an account, which is performed using standard procedures and standard Internet technology. After opening of the account, the parents are provided with two questionnaires, with a first questionnaire comprising questions regarding the individual's background—for example, date of birth, birth history issues, medical history, age, sex, grade level achieved, current school performance, language skills, family income, parental education level, known medical conditions, etc.—and a second questionnaire comprising questions with respect to the parents assessment/observations regarding the individual's abilities—for example, visual processing, auditory processing, sequential/rational processing, conceptual/holistic processing, processing speed, memory, multitasking, reasoning, organization/prioritization, etc. Preferably, the data indicative of the answers to the first and second questionnaire are encoded using, for example, the processor 120 prior transmission to the server computer 102 via the communication network 116, or alternatively are encoded by server computer upon transmission of the data thereto from the processor 120. Upon receipt at 10, the data are stored, preferably, in a coded fashion, in respective databases, i.e. background data base 108 and preliminary assessment database 110.

Games database 112 has stored therein a plurality of computer programs of games, preferably, commercially available games such as, for example, a Tetris-like game for being played on a computer or video game consoles station such as, for example, Xbox or Wii having various types of user interfaces such as, for example, a mouse, keyboard, joystick, and/or microphone. Present-day computer programs typically have an interface embedded therein to enable interaction with other computer programs such as, for example, an Application Programming Interface (API).

At 20, in one embodiment of the present invention, at least one of the plurality of games are selected in dependence upon the answers provided by the parent, individual and/or caregiver in relation to the individual. Preferably, the selection is related to, for example, the individual's age, gender, left or right handedness or such other criteria elicited through one or more answers to questions asked on the questionnaire, or alternatively, is related to one or more of the individual's weaknesses as perceived by the parent and as elicited through one or more answers to the questionnaires, the selected games comprising at least a functionality that is associated with assessing state of health of the individual playing the game. For example, a game may involve the individual seeing and identifying items that appear on the screen for short periods of time or another game involves an individual's alertness and hand-eye coordination by having the individual aiming a gun at a moving target. The APIs embedded in the game computer program enable another computer program to collect various data including data to the individual's visual abilities, vocabulary, alertness, hand-eye coordination, etc. Additionally, the APIs enable collection of data relating to other attributes of the individual's behaviour such as, for example, rapid irrelevant movement of a pointer/mouse or slow reaction. In respect of those games which do not have usable relevant APIs that enable another computer program to collect data including for example data relating to the individual's visual abilities, vocabulary, alertness, hand-eye coordination, etc., in one embodiment of the present invention, such games are modified to provide such APIs in a known manner.

Optionally, a game comprises an avatar which is adaptable to take on one or more characteristics of the individual based on, for example, one or more of the answers provided by the parent, individual and/or caregiver. For example, if the individual is a “good natured” individual, the avatar is adapted to represent a good natured person.

At 30, the selected game computer program is executed enabling the individual to play and to interact via a user interface. The selected game computer program is, for example, transmitted via the communication network to the personal computer 118, stored in the memory 122, and executed using the processor 120. Alternatively, the selected game computer program is remotely executed using, for example, processor 104 of the server computer 102 and communication therewith is provided via the communication network 116 to the personal computer 118 for the individual to interact therewith. As is evident, use of a personal computer is by example only and various other devices are also employable such as, for example, Xbox consoles, Wii consoles, video game consoles or wireless handheld devices.

At 40, an assessment computer program is executed, preferably using the processor 104 of the server computer 102 executing executable commands stored in memory 106, for communicating with the game computer program via the API embedded in the game computer program for collecting interaction data in dependence upon the interaction of the individual with the game computer program. Optionally, a translation layer is employed to enable communication between the game computer program and the assessment computer program. Via the APIs the assessment computer program collects data related to the interaction of the individual with the game computer program such as, for example, the reaction time between an object displayed on the display and the individual's reaction thereto, or the individual's accuracy in hitting a target displayed on the display. The interaction data are transmitted simultaneously during the execution of the game computer program or, alternatively, stored, for example, in the memory 122 and transmitted—in predetermined time intervals or upon a request generated during execution of the assessment computer program—to the processor 104.

At 50, user state data are determined in dependence upon the collected interaction data. The user state data are associated with a state of health of the individual. Preferably, the interaction data are associated with respective levels or ratings. For example, a very slow reaction time of the individual to a functionality of the game is associated with a level of 5, a very fast reaction time is associated with a level of 1, and reaction times there between are associated with levels 2, 3, and 4, accordingly. Preferably, the user state data also comprises at least some of the background data and the preliminary assessment data, for example, by associating a “NO” in a parent's answer with “0” and a “YES” with “1”.

TABLE 1
Indicator ID

| | |
|---|---|
| 0 | - no |
| 1 | - yes |
| 2 | Level 1 |
| 3 | Level 2 |
| 4 | Level 3 |
| 5 | Level 4 |
| 6 | Level 5 |
| 7 | Rating 1 |
| 8 | Rating 2 |
| 9 | Rating 3 |
| A | Rating 4 |
| B | RESERVED |
| C | RESERVED |
| D | RESERVED |
| E | RESERVED |
| F | RESERVED |

Table 1 illustrates the association of the answers as well as the levels and ratings with hexadecimal characters. The user state data are then meta-tagged and saved in assessment database 114 as a unique string of characters such as, for example,

### A23DF323211111000012EAABC1212AACA+.

Of course, there are numerous possibilities of associating and storing the data.

Optionally, reference user state data are provided—60. The reference user state data are, for example, data based on the interaction data of a healthy individual of a same age playing the same game. At 70, the user state data are compared with the reference user state data to determine a comparison result indicative of for example, a difference between the user state data and the reference user state data and a margin of error. Of course, there are numerous other possibilities of comparing the data, for example, as percentages or ratios, etc.

At 80, the data, preferably, comprising the user state data, and for example, the reference state data, the comparison result and at least some of the background data and preliminary assessment data are then provided to the individual, or to the parent or caregiver of the individual. For example, the individual, or the parent or caregiver of the individual, using the personal computer 118 access the account set up for the individual with the assessment service provider via the communication network 116 and are provided with the data. The individual, or the parent or caregiver of the individual is then able to forward the data to a medical practitioner for facilitating the medical practitioner's assessment and diagnosis of the state of health of the individual. Alternatively, the data are directly provided to the medical practitioner's computer 130 via the communication network 116, where the data are processed using processor 132 for displaying in a human comprehensible form on display 136. Optionally, the medical practitioner is enabled to further process the data via user interface 138 suitable for a diagnosis and to store the data in memory 134 for future reference.

The method for collecting data for facilitating the assessment of the state of health of an individual enables the collection of the interaction data in a fashion that is concealed from the individual, thus enabling assessments in the privacy of the individual's home and at the leisure of the individual's play. Furthermore, the method enables collection of the interaction data over a period of time. For example, every time when the individual plays the game, the game computer program communicates with the assessment program; collects the interaction data; and transmits the same to the processor 104.

The assessment computer program is, for example, stored as executable commands in the memory 106 of the server computer 102 and executed on the processor 104. Standard programming technologies are employed for implementing the method for collecting data for facilitating the assessment of the state of health of an individual using, for example, standard game computer programs having APIs embedded therein, object oriented programming techniques, and Structured Query Language (SQL) for managing the databases, but are not limited thereto. As is evident, the method for collecting data for facilitating the assessment of the state of health of an individual is not limited to game computer programs but is also implementable using computer programs for other applications such as, for example, text editors and flight simulators or other computer programs or applications.

In an alternative embodiment, the game computer program is selected in a different fashion, i.e. step 20 in FIG. 2a is replaced by steps 21 to 26 illustrated in FIG. 2b. At 21, a first game computer program is executed and interaction data of the individual playing therewith are collected—22. User state data are then determined—23—in dependence upon the collected interaction data and, optionally, compared—24—with reference user state data to determine a comparison result. The steps 21 to 24 are then repeated—25—for a predetermined number of different game computer programs. The user state data and, optionally, the comparison result then provide an indication of any negative deviations in the individual's abilities relative to the reference user state data and at least one of the game computer programs is then selected—26—in dependence upon the user state data and, optionally, the comparison result, which functionalities best address any negative deviations in the individual's abilities relative to the reference user state data.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. A method comprising:
a) executing a first computer program for enabling a user to interact therewith via a user interface, the first computer program enabling a second computer program to communicate therewith;
b) executing the second computer program for communicating with the first computer program for collecting interaction data in dependence upon the interaction of the user with the first computer program;
c) determining user state data in dependence upon the interaction data, the user state data being associated with a state of health of the user; and,
d) providing the user state data for facilitating assessment of the state of health of the user.

2. A method as defined in claim 1 comprising providing reference user state data.

3. A method as defined in claim 2 comprising:
comparing the user state data with the reference user state data and determining a comparison result; and,
providing the comparison result.

4. A method as defined in claim 1 comprising:
performing a) to c) using a plurality of different first computer programs; and,
selecting at least one of the plurality of first computer programs in dependence upon the user state data.

5. A method as defined in claim 4 comprising:
comparing the user state data with reference user state data and determining a comparison result; and,
wherein the at least one of the plurality of first computer programs is selected in dependence upon the user state data and the comparison result.

6. A method as defined in claim 1 comprising:
receiving at least one of user background data and user preliminary assessment data; and,
selecting at least one of a plurality of different first computer programs in dependence upon the at least one of user background data and user preliminary assessment data.

7. A method as defined in claim 1 comprising:
receiving at least one of user background data and user preliminary assessment data; and,
wherein the user state data are determined in dependence upon the at least one of user background data and user preliminary assessment data.

8. A method as defined in claim 1 wherein the first computer program enables the second computer program to communicate therewith via an application programming interface.

9. A method as defined in claim 1 wherein the first computer program is executed using a first processor and wherein the user state data are provided to a second processor connected to the first processor via a communication network.

10. A method as defined in claim 9 wherein the second computer program is executed using the second processor.

11. A method as defined in claim 1 wherein the interaction data are collected in a concealed fashion with respect to the user.

12. A method as defined in claim 1 wherein the user interaction is related to playing a game, the game comprising at least a functionality associated with an attribute of the state of health of the user.

13. A storage medium having stored therein executable commands for execution on a processor, the processor when executing the commands performing:
communicating with a computer program, the computer program when executing enabling a user to interact therewith via a user interface;
collecting interaction data in dependence upon the interaction of the user with the computer program;
determining user state data in dependence upon the interaction data, the user state data being associated with a state of health of the user; and,
providing the user state data for facilitating assessment of the state of health of the user.

14. A storage medium as defined in claim 13 wherein the processor when executing the commands collects the interaction data in a concealed fashion with respect to the user.

15. A storage medium as defined in claim 13 wherein the processor when executing the commands performs:
receiving reference user state data; and,
comparing the user state data with the reference user state data and determining a comparison result.

16. A storage medium as defined in claim 13 wherein the processor when executing the commands performs:
receiving at least one of user background data and user preliminary assessment data; and,
determining selection data indicative of at least one of a plurality of different computer programs in dependence upon the at least one of user background data and user preliminary assessment data.

17. A storage medium as defined in claim 13 wherein the processor when executing the commands performs:
receiving at least one of user background data and user preliminary assessment data; and,
determining the user state data in dependence upon the interaction data and the at least one of user background data and user preliminary assessment data.
